(19) United States
(12) Patent Application Publication
(10) Pub. No.: US 2020/0027139 A1
(43) Pub. Date: Jan. 23, 2020

(54) SYSTEM, METHOD, AND NON-TRANSITORY COMPUTER-READABLE STORAGE MEDIA FOR PROVIDING REFERRALS

(71) Applicant: Rania Nasreddine, Tulsa, OK (US)

(72) Inventor: Rania Nasreddine, Tulsa, OK (US)

(21) Appl. No.: 16/438,944

(22) Filed: Jun. 12, 2019

Related U.S. Application Data
(60) Provisional application No. 62/685,086, filed on Jun. 14, 2018.

(51) Int. Cl. G06Q 30/02; H04L 29/06; G06Q 10/10

(52) U.S. Cl. CPC G06Q 30/0282; G06Q 10/107; H04L 63/08; H04L 63/102

(57) ABSTRACT

Systems, methods, and computer products for providing referrals are disclosed. A user accesses a referral service website or application and creates a user account. The user is verified to provide referrals. The verification is sent to a communications unit, which sends a message to the user requesting the user complete a single step to provide a new referral for a business for a category of goods or services wherein the single step comprises providing a response selected from not more than two available response options. The user account is updated to include the new referral.

### CROSS-REFERENCE TO RELATED APPLICATION

This application claims the benefit of U.S. Provisional Patent Application No. 62/685,086, filed on Jun. 14, 2018, the entire disclosure of which is herein incorporated by reference.

### FIELD OF THE INVENTION

The present invention relates to referral systems. More particularly, the present invention relates to systems, methods, and non-transitory computer-readable storage media for providing referrals via an online referral system.

### BACKGROUND

Online recommendation systems are ways in which consumers rate products and services, for example, hotels, restaurants, retailers, personal care service providers, medical providers, and consumer products. Commonly, recommendation systems aggregate user reviews into online databases that are searchable by consumers. Many current recommendation systems allow a user to assign a score that is numerical or alphabetical, within a fixed scale having a minimum and a maximum rating (e.g., 1 through 5, A through F, etc.). Alternatively, some systems allow a user to select a number of stars (or other symbol) out of a fixed number of the same (e.g., one star out of five stars) to indicate a rating. In addition or alternatively, some systems may allow a user to provide written comments within a blank text field. Some systems require the user to complete one or the other of a rating and written comments, but not both, whereas other systems require all components to be completed by the user before accepting the review.

After all required components of the review are complete, and if all other requirements have been met (e.g., registration, compliance with terms of use, etc.) and the product or service is eligible to receive a review on the online review system, then the review will typically be displayed on a web page associated with the product or service. Even if a review is accepted for purposes of calculating an overall rating, in some cases, the review may not be eligible to appear on the web page associated with the product or service if less than all components of the review are completed (such as optional written comments). In other systems, reviews that include all components may be given priority over those that do not, for purposes of choosing which reviews are posted on the web page.

In these recommendation systems, typically all ratings for a product or service are aggregated to provide an average rating visible to the public. Consumers often rely on these ratings to choose products or services. Therefore, when users of the recommendation system choose ratings at either end of the rating scale, this can drastically alter the average rating, which in turn may affect other consumers' ultimate decision to purchase the product or service.

Moreover, these current systems require users to complete multiple steps in order to leave a review for a product or service, which can be time-consuming and frustrating. This multi-step process is often a disincentive for leaving a review, even where a user might be interested in leaving feedback about the product or service. In general, consumers who had a negative experience tend to be more willing to complete the process, perhaps because they feel they should warn future potential consumers and/or due to a desire to use the review as a public reprimand of a business that provided the perceived negative experience. Therefore, it is generally more difficult for businesses to receive positive reviews than negative reviews, even if customers are largely satisfied with the product or service. Moreover, regardless of the legitimacy of a negative review, businesses typically have little or no control over the review once it has been posted, and therefore they must find other ways to mitigate the damages caused by an unfair or inaccurate review.

Finally, current recommendation systems typically allow a user to review an unlimited number of products or services, even within the same product or service category. For example, a user could leave a 5-star review for two different hairstylists within the same city. One of these may be the user's past hairstylist and the other may be the consumer's current hairstylist, but a consumer viewing the rating (or even perhaps reading the comments) would not necessarily have this information and, therefore, may not know which one is the user's most recent recommendation. Moreover, there is nothing to stop a user from simply reviewing multiple businesses within a category just because they happen to know or like more than one provider. For example, a reviewer who is friends with multiple hairstylists has no reason not to write a glowing review for each of them, even if she uses only one of them for her own needs. Again, consumers reading the reviews would not be privy to this information, which necessarily biases the review. Therefore, these system defects may lead to skewed ratings that are less than helpful to consumers seeking current and unbiased recommendations.

A referral system designed to overcome one or more of the aforementioned challenges is desired.

### SUMMARY OF THE INVENTION

In different embodiments of the present invention, systems, methods, and computer-readable storage media allow online referrals for products and/or services.

In one embodiment of the present invention, a system is provided for providing online referrals. The system comprises a database stored on a server, a referral application associated with a referral service and installed on a user device accessible to a user, the user device comprising a user interface, and a processing device of the server. The processing device is in communication with the user device. The processing device includes a profile management unit, a communications unit, and a hosting unit. The profile management unit is configured to store a plurality of referrals provided by the user in a user account associated with the user. The communications unit is configured to send a message to the user requesting the user complete a single step to provide a new referral for a business for a category of goods or services, wherein the single step comprises providing a response selected from not more than two available response options. The hosting unit is configured to receive the new referral from the user, and send the new referral to the profile management unit for storage in the user account.

In another embodiment of the present invention, a computer-implemented method for providing online referrals is disclosed. A user is prompted to access, by a hosting unit, a referral service website associated with a referral service. The user is prompted to create, by a profile management unit, a user account. An authentication unit verifies that the user is eligible to create the user account by comparing information provided by the user with user information stored in the database. A communications unit receives the verification from the authentication unit. The communications unit sends a message to the user requesting the user complete a single step to provide a referral for a business for a category of goods or services, wherein the single step comprises providing a response selected from not more than two available response options. The hosting unit receives the new referral from the user. The hosting unit sends the new referral to the profile management unit.

In still another embodiment of the present invention, a system comprises a database stored on a server, a referral application associated with a referral service and installed on a user device accessible to a user and including a user interface, and a processing device of the server. The processing device is in communication with the user device. The processing device includes a hosting unit, a profile management unit, an authentication unit, and a communications unit. The hosting unit is configured to prompt a user to access the application. The profile management unit is configured to prompt the user to create a user account. The authentication unit is configured to verify that the user is eligible to create the user account by comparing information provided by the user with user information stored in the database. The communications unit is configured to receive the verification from the authentication unit, and send a message to the user requesting the user complete a single step to provide a new referral for a business for a category of goods or services, wherein the single step comprises providing a response selected from not more than two available response options. The hosting unit is further configured to receive the new referral from the user, and send the new referral to the profile management unit. The profile management unit is further configured to determine whether there the user has an existing referral for the category, where the user has an existing referral for the category, remove the existing referral, and update the user account to include the new referral. The hosting unit is further configured to prompt a business user to access the application. The profile management unit is further configured to prompt the business user to create a business account. The authentication unit is further configured to verify that the business user is eligible to accept referrals by comparing information provided by the business user with business information stored in the database. The profile management unit is further configured to update the business account to include the referral from the user.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present disclosure;

FIG. 2 is a schematic illustrating example components of a server, according to a first embodiment of the present invention;

FIG. 3A is a flowchart of a first method that may be used with the system shown in FIG. 1;

FIGS. 3B-3E are exemplary screenshots of the graphical user interface of the system of FIG. 3A;

FIG. 4A is a flowchart of a second method that may be used with the system shown in FIG. 1;

FIGS. 4B-4F are exemplary screenshots of the graphical user interface of the system of FIG. 4A;

FIG. 5A is a flowchart of a third method that may be used with the system shown in FIG. 1;

FIGS. 5B-5C are exemplary screenshots of the graphical user interface of the system of FIG. 5A;

FIG. 6A is a flowchart of a fourth method that may be used with the system shown in FIG. 1;

FIGS. 6B-6D are exemplary screenshots of the graphical user interface of the system of FIG. 6A;

FIG. 7A is a flowchart of a fifth method that may be used with the system shown in FIG. 1;

FIGS. 7B-7F are exemplary screenshots of the graphical user interface of the system of FIG. 7A;

FIG. 8 is an exemplary screenshot of a graphical user interface featuring a user's referrals of the system shown in FIG. 1;

FIG. 9 is a flowchart of a sixth method that may be used with the system shown in FIG. 1; and

FIG. 10 is a flowchart of a seventh method 700 that may be used with the system shown in FIG. 1.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

An online referral system that limits the type and amount of referrals allowed by a single user is disclosed. The referral system of the present invention prevents users from reviewing a product or service based on a traditional scale (e.g., numerical or alphabetical) or a written review. It also prohibits users from making more than one referral at a time in each category of product or service. Instead, the system of the present invention allows a user to refer only one provider or product per category of product/service. The act of referring the provider or category constitutes the entire referral/review, since a user may only make a single referral within each category. The system may allow the user to change the referral to a different provider or service, but only one may be listed at any given time. Moreover, some of the methods disclosed herein require the user to take only a single step to provide a referral.

Referral System Architecture

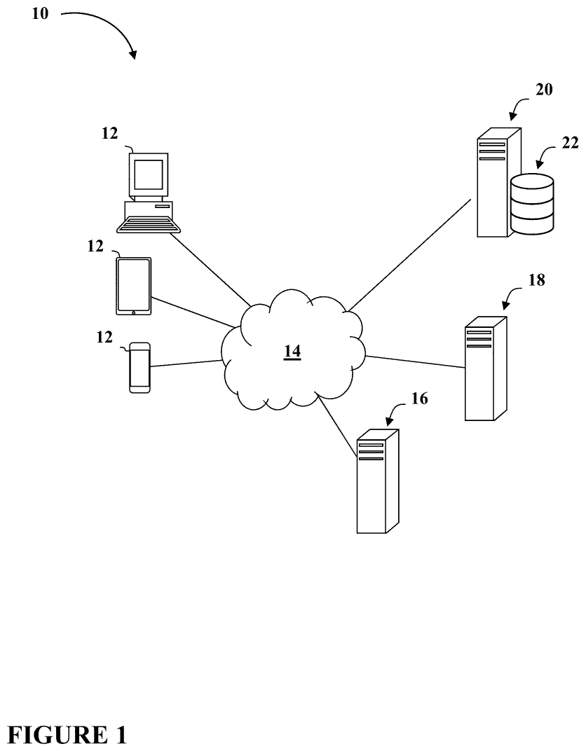

With reference to the FIGS. and in operation, the present invention provides a referral system 10, methods and computer product media to allow online referrals for products and/or services. In general use, the system includes a processing device that allows a user (e.g., a customer) to provide a referral for a product and/or service, or to search for referrals made by other users for products and/or services, via a website or an application, i.e., “app”, running on a user device. Referring to FIG. 1, an exemplary environment in which the system 10 operates is illustrated. In the illustrated embodiment, the system 10 is configured to enable a user to access a website with one or more user computing devices 12 to provide or search for referrals.

For clarity in discussing the various functions of the system 10, multiple computers and/or servers are discussed as performing different functions. These different computers (or servers) may, however, be implemented in multiple different ways such as modules within a single computer, as nodes of a computer system, etc. The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

In the illustrated embodiment, the system 10 includes a host server 16, a referral server 18, a database server 20, a database 22, and one or more user computing (or customer) devices 12 that are each coupled in communication via a communications network 14. The communications network 14 may be any suitable connection, including the Internet, file transfer protocol (FTP), an Intranet, LAN, a virtual private network (VPN), cellular networks, etc . . . , and may utilize any suitable or combination of technologies including, but not limited to wired and wireless connections, always on connections, connections made periodically, and connections made as needed.

The user computing device 12 may include any suitable device that enables a user to access and communicate with the system 10 including sending and/or receiving information to and from the system 10 and displaying information received from the system 10 to a user. For example, in one embodiment, the user computing device 12 may include, but is not limited to, a desktop computer, a laptop or notebook computer, a tablet computer, smartphone/tablet computer hybrid, a personal data assistant, a handheld mobile device including a cellular telephone, and the like. The user computing device 12 may be used to by a user, such as a customer, to provide a referral for a product or service.

The host server 16 may be configured to host a website or provide data to the app that is accessible by a user via one or more user computing devices 12. For example, the host server 16 may retrieve and store a web page associated with one or more websites in response to requests received by the user via the user computing device 12 to allow users to interact with the website and provide referrals via the website. In one embodiment, the host server 16 is configured to generate and display a web page associated with the website in response to requests being received from consumers via corresponding web browsers that are displayed on the user computing devices 12.

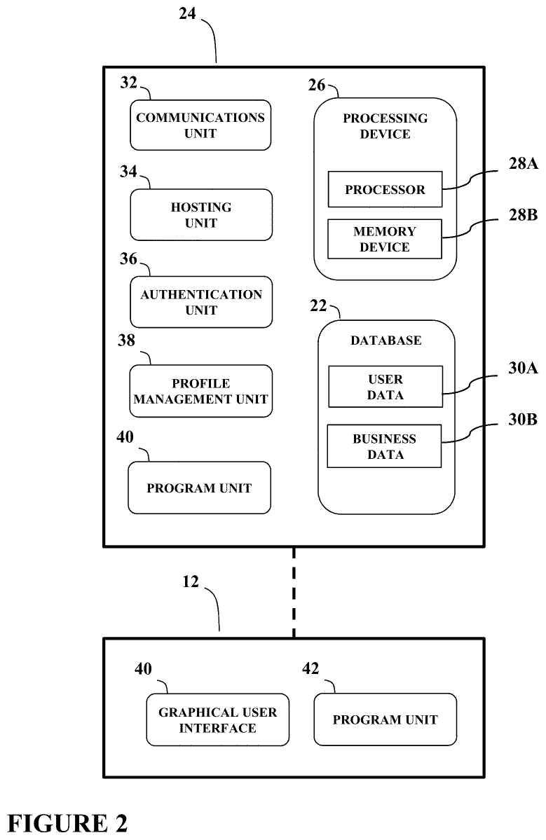

Referring to FIG. 2, in one embodiment, the system 10 may include a system server 24 communicatively coupled to user computing device 12. System server 24 is configured to perform the functions of the host server 16, the referral server 18, and/or the database server 20. In the illustrated embodiment, the system server 24 includes a processing device 26 and the database 22.

The processing device 26 executes various programs, and thereby controls components of the system server 24 according to user instructions received from the user computing device 12. The processing device 26 may include a processor or processors 28A and a memory device 28B, e.g., read only memory (ROM) and random access memory (RAM), storing processor-executable instructions and one or more processors that execute the processor-executable instructions. In embodiments where the processing device 26 includes two or more processors 28A, the processors 28A can operate in a parallel or distributed manner. In an example, the processing device 26 may execute and/or implement a communications unit 32, a hosting unit 34, an authentication unit 36, and a profile management unit 38.

The user computing device 12 comprises a graphical user interface 40 and a program unit 42, which may run a computer-readable program on user computing device 12.

The database server 26 includes a memory device 28A that is connected to the database 22 to retrieve and store information contained in the database 22. The database 22 contains information on a variety of matters, such as, for example, user account/profile information 30A, business information 30B, and/or any suitable information that enables the system 10 to function as described herein.

The memory device 28B may be configured to store programs and information in the database 22, and retrieve information from the database 22 that is used by the processor to perform various functions described herein. The memory device 28B may include, but is not limited to, a hard disc drive, an optical disc drive, and/or a flash memory drive. Further, the memory device may be distributed and located at multiple locations.

In one embodiment of the present invention, the memory device 28B may include one or more of the memory devices and/or mass storage devices of one or more of the computing devices or servers. The modules that comprise the invention are composed of a combination of hardware and software, i.e., the hardware as modified by the applicable software applications. In one embodiment, the units of the present invention are comprised of one of more of the components of one or more of the computing devices or servers, as modified by one or more software applications.

The communications unit 32 retrieves various data and information from the database 22 and sends information to the user computing device 12 via the communications network 14 to enable the user to access and interact with the system 10. In one embodiment, the communications unit 32 displays various images on the graphical interface 40 of the user computing device 12 preferably by using computer graphics and image data stored in the database 22 including, but not limited to, web pages and/or any suitable information and/or images that enable the system 10 to function as described herein.

The hosting unit 34 may be programmed to perform some or all of the functions of the host server 16 including hosting various web pages associated with one or more websites that are stored in the database 22 and that are accessible to the user via the user computing device 12. The hosting unit 34 may be programmed to generate and display web pages associated with a website in response to requests being received from users via corresponding web browsers.

In one embodiment of the present invention, the authentication unit 36 may authenticate requests received from users via user computing device 12. The memory device 28B may retrieve information from the database 22 about the user to determine authentication.

The profile management unit 38 may maintain a plurality of profiles associated with users stored in database 22. The communications unit 32 may further send information about referrals to the user, such as by e-mail, text message, or push notification.

In order to utilize the referral system described herein, a user may be required to register with a referral service that utilizes the referral described herein. Similarly, those businesses desiring referrals (e.g., service providers, manufacturers, retailers, etc.) may also be required to register with the referral service.

User Account Registration

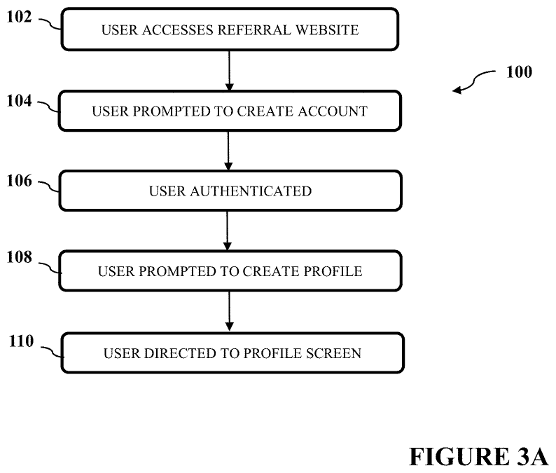

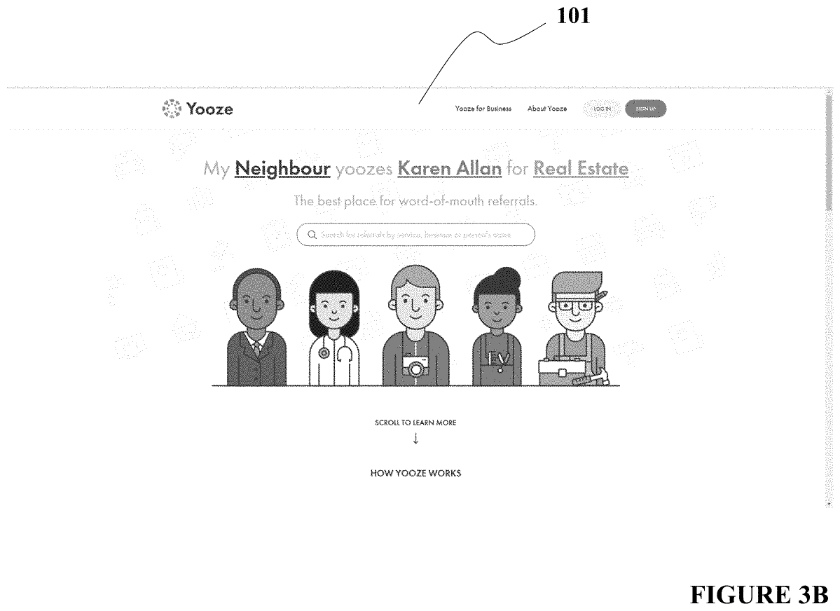

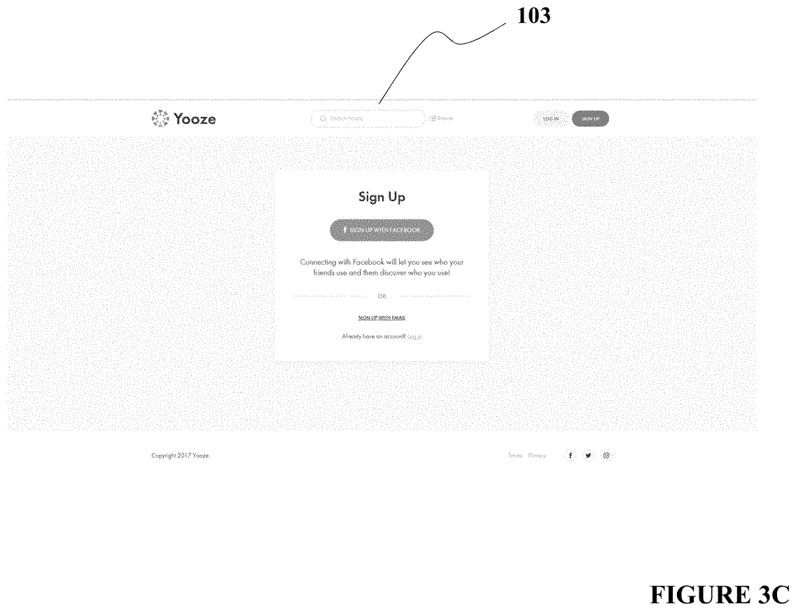

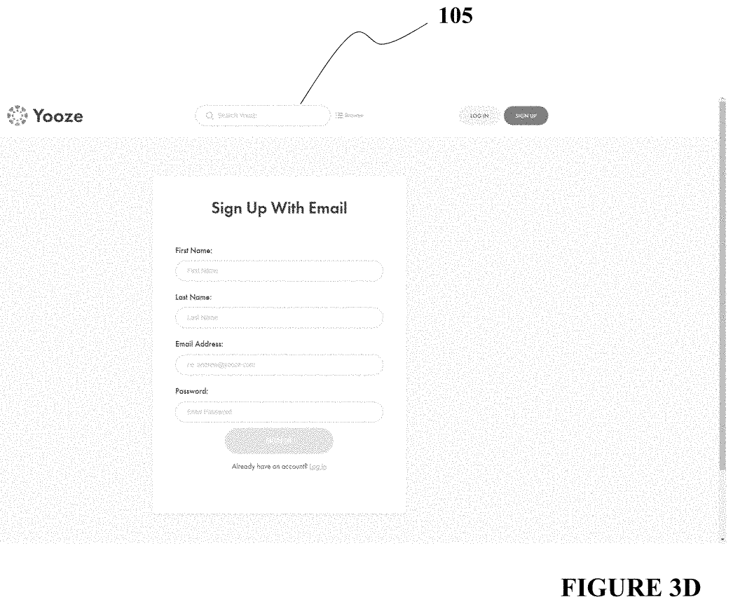

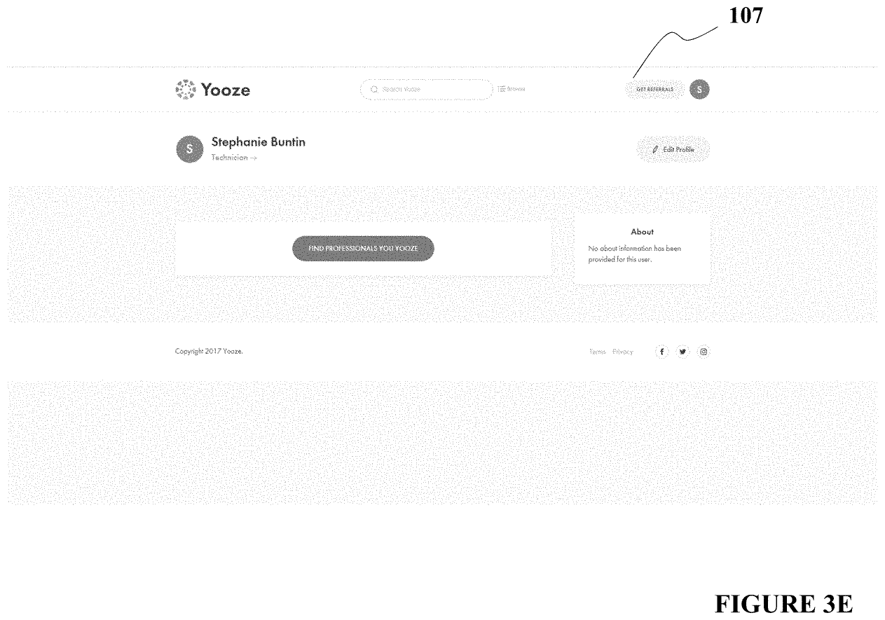

FIG. 3A is a flowchart of a first method 100 that may be used with the system 10 to allow a processing device to allow users to register with a referral service. FIGS. 3B-E are exemplary screenshots of the graphical user interface of the system of FIG. 3A. The method includes a plurality of steps. Each method step may be performed independently of, or in combination with, other method steps. Portions of the method may be performed by any one of, or any combination of, the components of the system 10.

In a first step 102, a user accesses, via the communications unit 32 and the hosting unit 34, a referral website 101 associated with the referral service (see FIG. 3B). The first time the user accesses the website 101, the user is considered a guest, but may be required to register a user account in order to provide a referral.

In a second step 104, the user may be prompted, by the profile management unit 38, to create a user account at a sign-up landing page 103 (see FIG. 3C). On an account creation page 105 (see FIG. 3D), the user may be required to provide personal information, e.g., name, address, phone number, e-mail address, and/or any other information relevant to identify the user as a legitimate consumer and prevent users from creating multiple accounts for the purpose of bypassing the system limitations on numbers of referrals per user. The user may also be prompted to set up a password for the account. In some embodiments, the user may also be required to sign or accept a pledge to only provide referrals for businesses or professionals that they have personally used.

Alternatively, the sign-up landing page 103 may allow the user to create an account via another means, such as by connecting one of the user's existing social media account that already contains all of the relevant information about the user.

In a third step 106, the authentication unit 36 determines whether the user is a first-time user or an existing user based on comparing the received personal information against information stored about users in database 22. If the user is an existing user, the communications unit 32 sends the information to the hosting unit 34, which presents an error screen to the user indicating an account already exists with the user's information and denying the creation of a new account, thereby preventing the creation of multiple user accounts associated with a single user. If a user has forgotten his login credentials (e.g., user name or password), he may be prompted to answer security questions to reset, or to enter an e-mail address associated with the account to trigger an e-mail with reset instructions or temporary credentials.

In a fourth step 108, if the user is a new user, the communications unit 32 sends the information to the hosting unit 34, which presents a profile screen 107 to the user (see FIG. 3E). At the user profile screen 107, the user may be able to view or access a variety of information, which may include, for example, user preferences, current referrals, referral history, and user account information. Some information may be private, such as user preferences and account information, and thus viewable only by the user. Some other information may be shared. For instance, the user's referrals in all categories may be viewable by other registered users and/or the public on the user profile screen. In some embodiments, the user's current referrals and/or referral history may be private. The user may change out referrals at any time (e.g., replace one business with another business for any given category). The individual user may also connect her account to other social media accounts (if not done at the account creation stage). When this is done, the user may view which of her friends on the social media platform are also using the referral system, share links from the referral system on those social media accounts, and/or give businesses/professionals “shout outs” on social media accounts when she has received good service. From the user profile page, the user may also view friends' profiles, save businesses/professionals to an internal list for later reference, claim a business account, message a business/professional to inquire about services or availability, and/or invite other people to join the referral system (e.g., by e-mail, text message, social media platform, etc.).

The profile management unit may also allow the user to log out of the account at any time after the account has been created and the user has logged in. The profile management unit may also allow the user to delete the account, although in some embodiments there may be additional security steps required to delete the account (e.g., an e-mail notification is sent to the user's primary e-mail to confirm the account should be deleted, to which the user must respond, or the like).

Business Account Registration

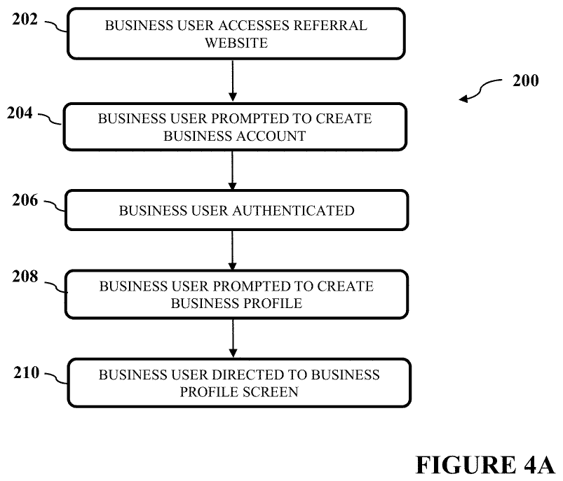

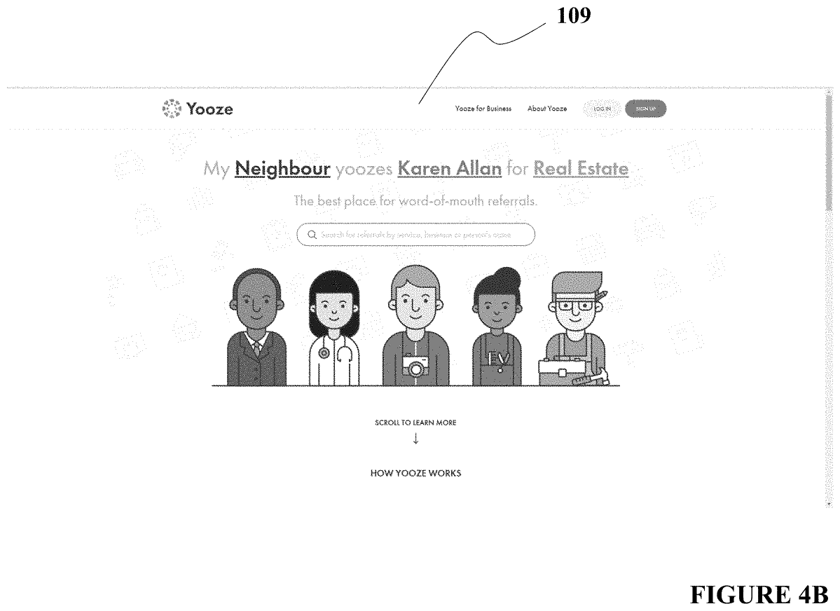

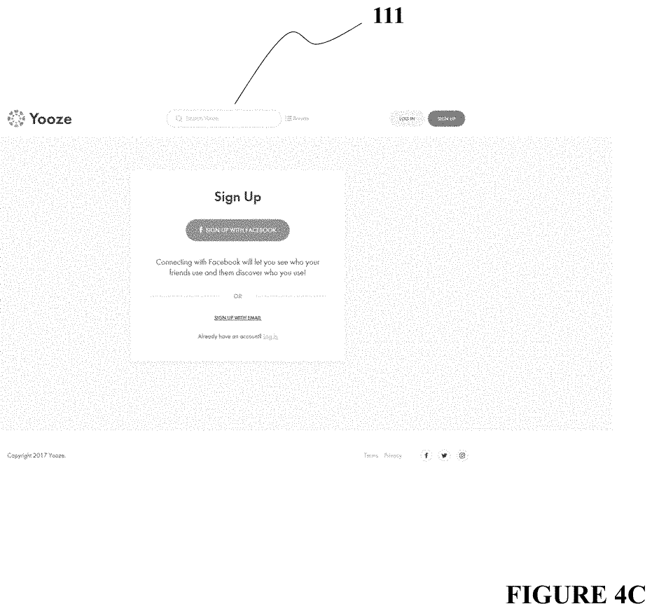

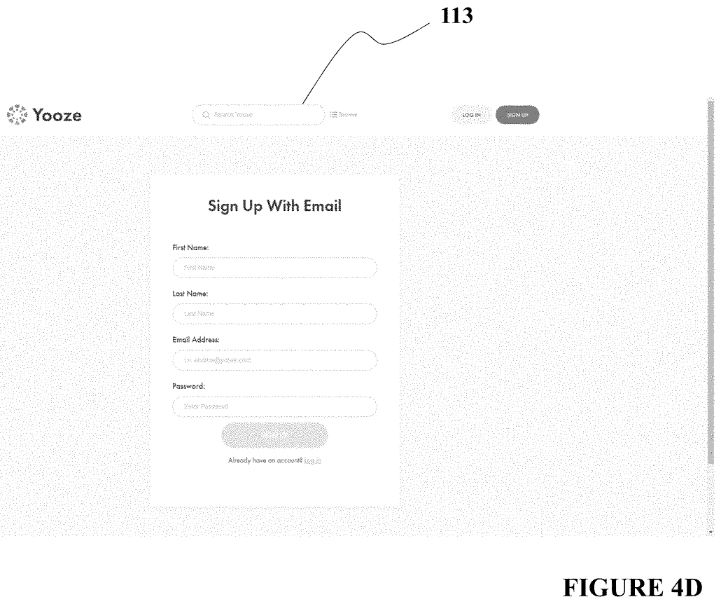

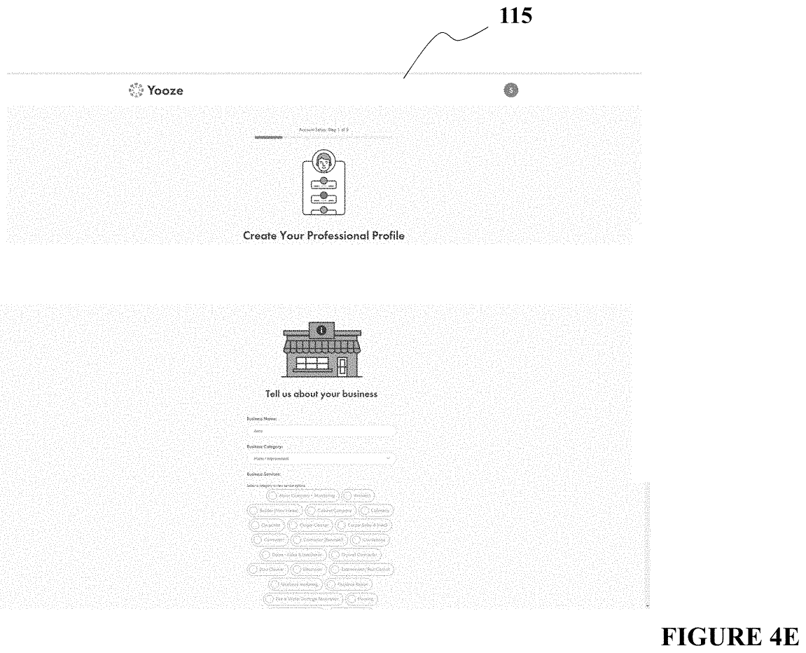

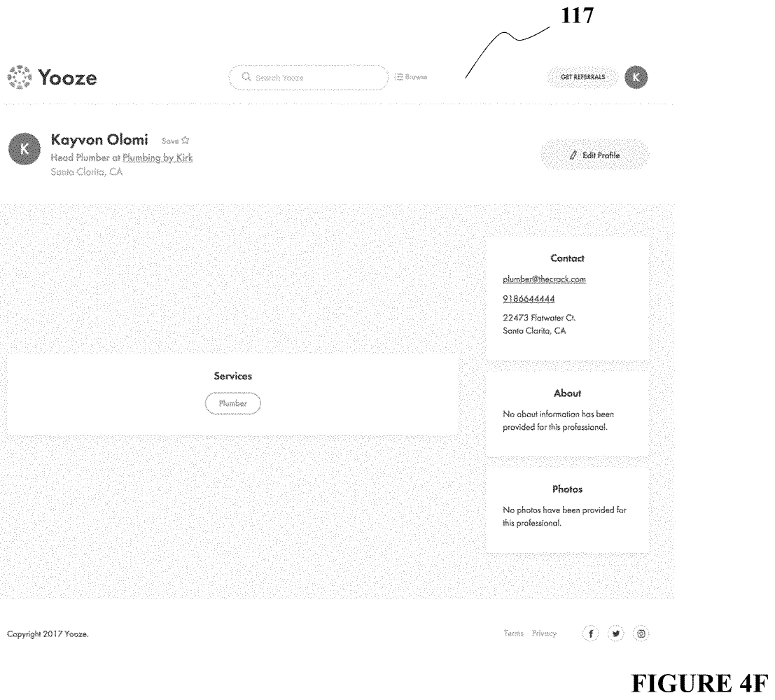

FIG. 4A is a flowchart of a second method 200 that may be used with the system 10 to allow a processing device to allow businesses (e.g., service providers, retailers, manufacturers, etc.) to register with a referral service. FIGS. 4B-F are exemplary screenshots of the graphical user interface of the system of FIG. 4A. It will be understood that, as used throughout, the term “business” may refer to the business itself or an individual professional (e.g., a salon or a hairdresser who works at the salon). The method includes a plurality of steps. Each method step may be performed independently of, or in combination with, other method steps. Portions of the method may be performed by any one of, or any combination of, the components of the system 10.

In a first step 202, a user acting behalf of a business accesses, via the communications unit 32 and the hosting unit 34, a referral website 109 associated with the referral service (see FIG. 4B). The first time the user accesses the website 109, the user is considered a guest. In some embodiments, the user may be required to register a business account in order for the business to begin receiving referrals. In yet another embodiment, the user may not be required to register a business account in order for the business to begin receiving referrals, as long as the information for the business is accessible by the system (e.g., may be pulled from a search engine or social media platform).

In a second step 204, the user may be prompted, by the profile management unit 38, to create a business account at a sign-up landing page 111 (see FIG. 4C). On an account creation page 113 (see FIG. 4D), the user may be required to provide personal information about a primary user of the account, e.g., name, address, phone number, e-mail address, and/or any other information relevant to identify the user and confirm the user is actually associated with and entitled to act on behalf of the business. The user may also be prompted to set up a password for the account.

In a third step 206, the authentication unit 36 determines whether there is already a business account associated with the business, based on comparing the received information against information stored about businesses in database 22. If there is already a business account associated with the business, the communications unit 32 sends the information to the hosting unit 34, which presents an error screen to the user indicating a business account already exists for the business and denying the creation of a new account. If a user has forgotten the business account login credentials (e.g., user name or password), he may be prompted to answer security questions to reset, or to enter an e-mail address associated with the account to trigger an e-mail with reset instructions or temporary credentials.

In a fourth step 208, if a new business account has been created, the user is prompted to create a business profile at a profile creation screen 115 (see FIG. 4E). At the profile creation screen 115, the user may enter information about the business or individual associated with the account, including, for example, a business or individual name and location, a profession or category of services, and one or more subcategories of services (e.g., category: home improvement services; subcategory: heating and cooling; additional subcategory: air conditioning repair).

In a fourth step 210, the user may be directed to a business profile screen 117 (see FIG. 4F). At the business profile screen 117, the user may be able to view or access a variety of information, which may include, for example, business account preferences, customer history, customer referrals, and other data/statistics associated with referrals for the business, and business account information. Under customer history, the business may input information associated with customers who have purchased products and/or services from the business, including, for example, a name and an email address. Some information may be private, such as business account preferences and account information, and thus viewable only by the business and its authorized users. Some information may be shared. For instance, all referrals for the business may be viewable by other registered users and/or the public on the business profile screen. In some embodiments, current/past referrals may not be viewable by any user except the business and its authorized users.

From the business profile screen 117, the user may be able to perform a variety of functions, including: adding/removing services or categories, adding/removing photographs associated with the business, link an individual professional's page to a business' page, unlink an individual professional's page from the business' page (and the professional may likewise request to be linked to a business' page or replace an existing business with a different business), link the business account to other social media accounts (if not done at the account creation stage). When this is done, the user may view which of her friends on the social media platform are also using the referral system, share links from the referral system on those social media accounts, view outstanding referral requests to see which customers have and have not responded to a referral request (and which have denied to provide a referral), send messages to existing customers (e.g., offers or advertisements), respond to messages/inquiries from prospective customers about services and availability, and/or invite other people to join the referral system (e.g., by e-mail, text message, social media platform, etc.).

The profile management unit may also allow the user to log out of the account at any time after the account has been created and the user has logged in. The profile management unit may also allow the user to delete the account, although in some embodiments there may be additional security steps required to delete the account (e.g., an e-mail notification is sent to the user's primary e-mail to confirm the account should be deleted, to which the user must respond, or the like).

In one embodiment, a business account may be merged with an individual (personal) account so that the user may act as a business but also as a consumer that gives referrals to other businesses.

It will be understood that, although individual user account creation and business account creation are discussed herein, a user may not be required to register for an account in order to perform certain functions on the referral system, e.g., searching for referrals, viewing business profiles, etc. The system administrator may determine which of the functions require registration and which do not. For example, a business profile may be viewable to an anonymous user, but an individual user's profile and recommendations may be viewable only by other registered users.

One-Click E-Mail Referral Method

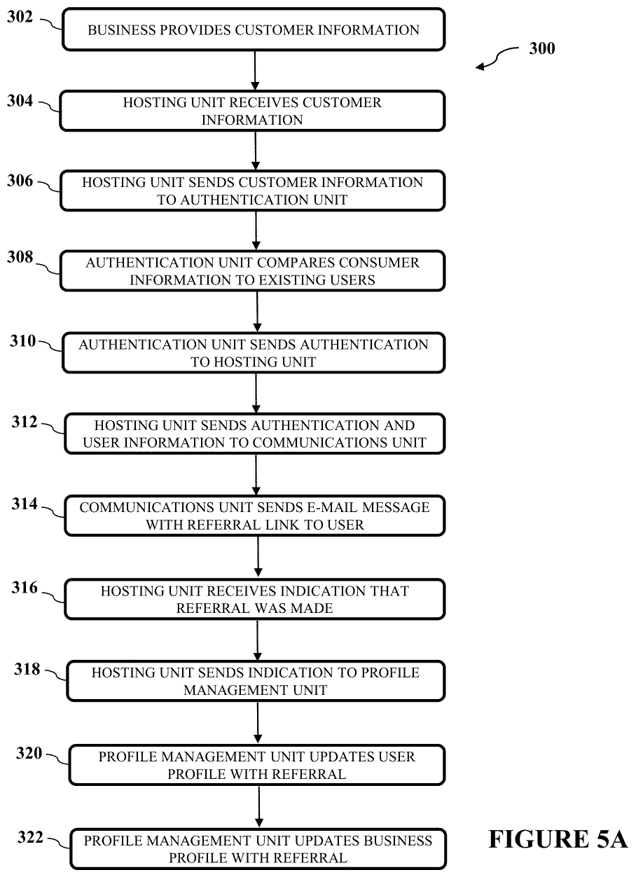

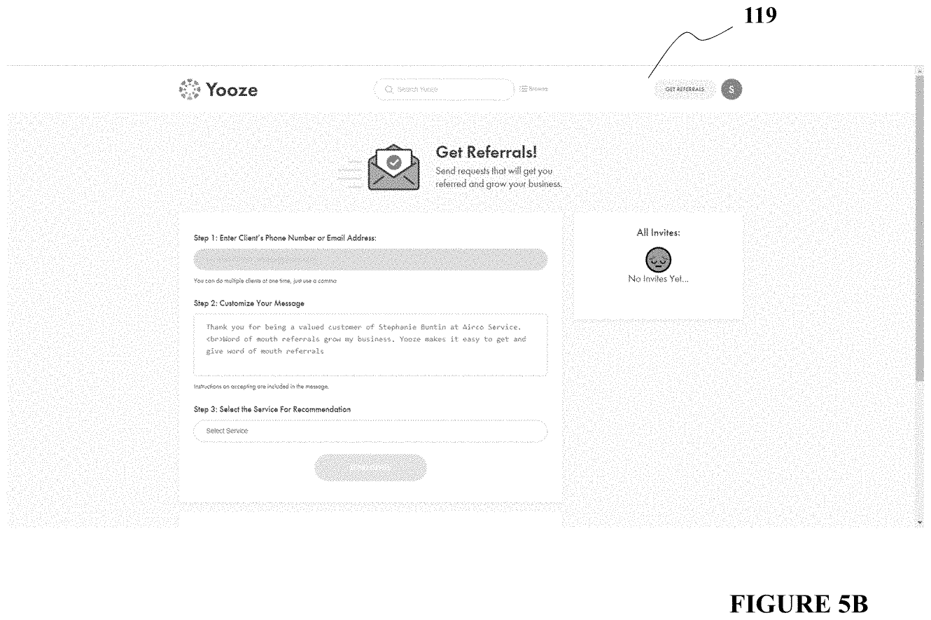

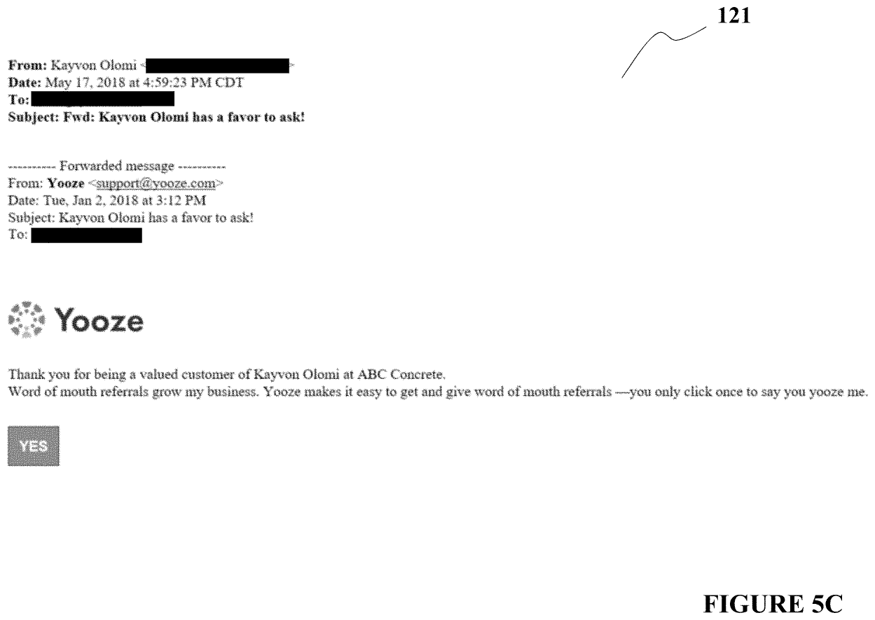

FIG. 5A is a flowchart of a third method 300 that may be used with the system 10 to allow a processing device to allow registered users to provide a one-click referral by e-mail. FIGS. 5B-C are exemplary screenshots of the graphical user interface of the system of FIG. 5A. The method includes a plurality of steps. Each method step may be performed independently of, or in combination with, other method steps. Portions of the method may be performed by any one of, or any combination of, the components of the system 10.

In a first step 302, at a referral request page 119 (see FIG. 5B), a business provides customer information, comprising at least an email address associated with a customer, via the referral website associated with the referral service.

In one embodiment, the business may be able to enter multiple e-mail addresses at once (e.g., by uploading a CSV file or the like). However, in this embodiment, there may be additional features that prevent “spamming” by entering phone numbers or e-mail addresses that are not associated with customers or that were not provided by actual customers. For example, the terms of service of the referral system may prohibit such spamming, or a maximum number of requests may be allowed (e.g., only 100 contacts may be added at once, or 100 requests may be sent per month, etc.). On the consumer's side, there may be provided a link to “opt-out” of further communications from the referral system or to indicate that the referral requestor is not recognized by the consumer. Businesses who abuse this feature may have their accounts suspended or deleted.

In a second step 304, the hosting unit 34 receives the customer information.

In a third step 306, the hosting unit 34 sends the customer information to the authentication unit 36.

In a fourth step 308, the authentication unit 36 compares the customer information against information stored about users in database 22 to determine whether the customer information is associated with a registered user.

In a fifth step 310, the authentication unit 36 sends authentication to the hosting unit 34, indicating that the customer information matches a registered user.

In a sixth step 312, the hosting unit 34 sends the authentication information and the customer information to the communications unit 32.

In a seventh step 314, the communications unit 32 sends an e-mail message 121 to the user using the customer information (see FIG. 5C). The e-mail message 121 asks whether the user would like to provide a referral for the business in a category, and provides a link for the user to click if the user wishes to provide a referral.

In an eighth step 316, the hosting unit 34 receives an indication that the user clicked the link to provide a referral.

In a ninth step 318, the hosting unit 36 sends the indication to the profile management unit 38.

In a tenth step 320, the profile management unit 38 updates the user profile to reflect the referral to the business. If the user already has a referral listed in the same category, the profile management unit 38 replaces the existing referral with the new referral. In some embodiments, before the profile management unit 38 replaces the existing referral with the new referral, the communications unit 32 may first send a notification to the user to confirm that the user wishes to replaces the existing referral with the new referral. The notification may require the user to click a link or to provide a one-word or one-letter response (e.g., “YES” or “Y”) to confirm the replacement.

In an eleventh step 322, the profile management system 38 updates the business user profile to reflect the referral by the user.

In some embodiments, where the authentication unit 36 determines that the customer information does not match a registered user, the communications unit 32 may still send an e-mail message to the non-registered user using the customer information. However, instead of containing a referral link the e-mail message may include a request that the user register with the referral system in order to be eligible to provide a referral. The e-mail message may include a link to the web site of the referral service, whereby the user may register an account according to method 100 (see FIG. 3A).

In yet another embodiment, where authentication unit 36 determines that the customer information does not match a registered user, the communications unit 32 may still send an e-mail message to the non-registered user using the customer information. Instead of soliciting the user to set up an account, the system may accept the user's referral and automatically set up an account for the user based on the provided e-mail address as a unique identifier and update the user's account with the referral. Thus, the user is not required to independently set up an account, download an application to his phone, or take any other action besides responding to the e-mail message in order to provide the referral.

One-Word Text Message Referral Method

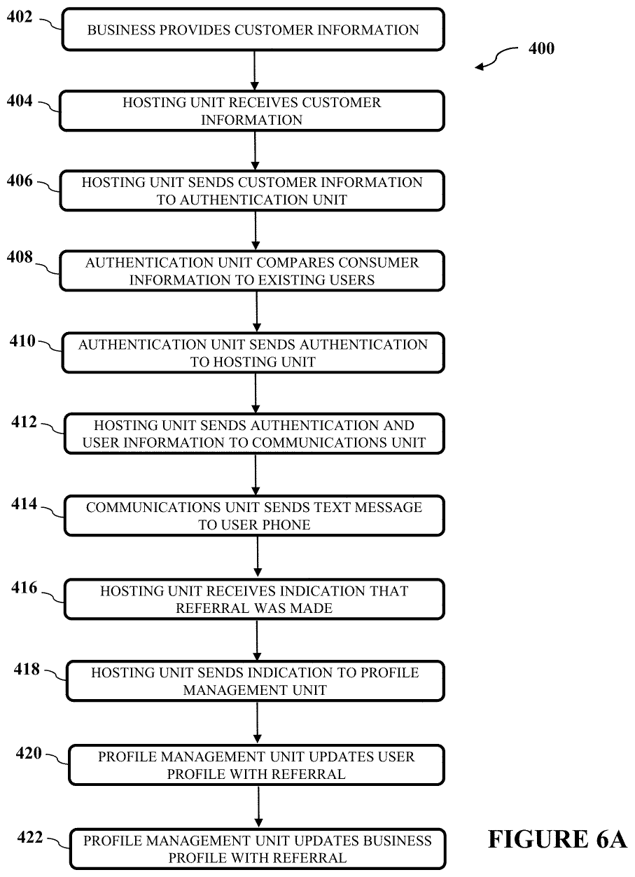

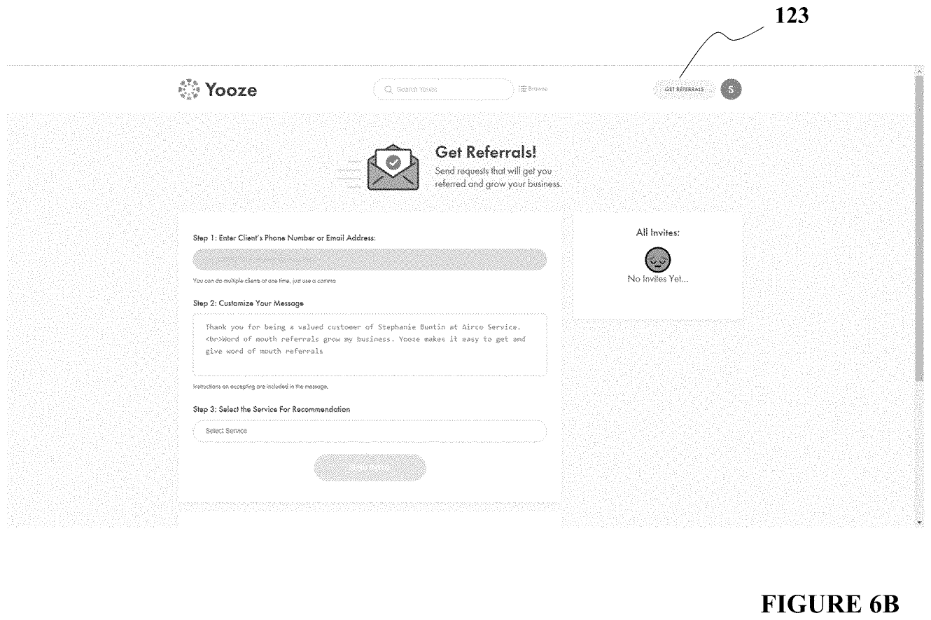

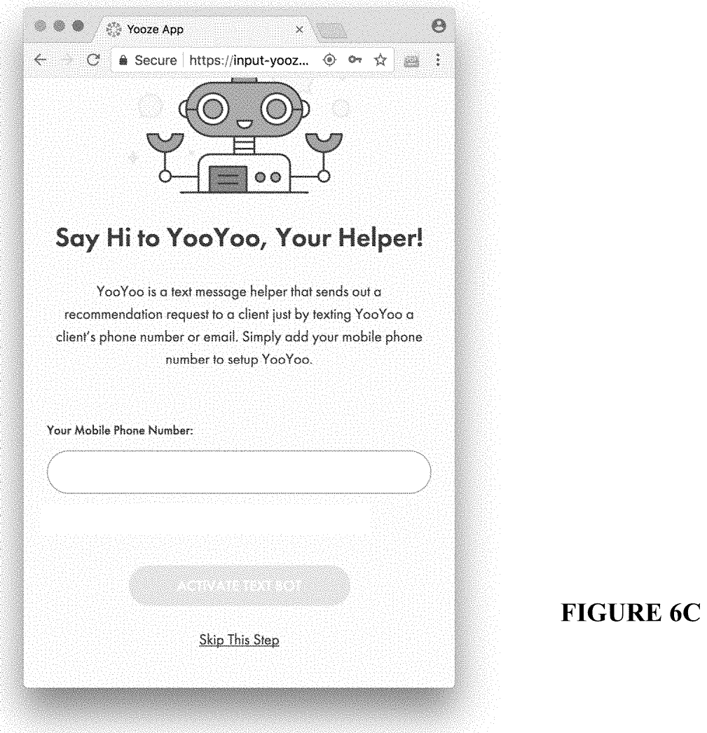

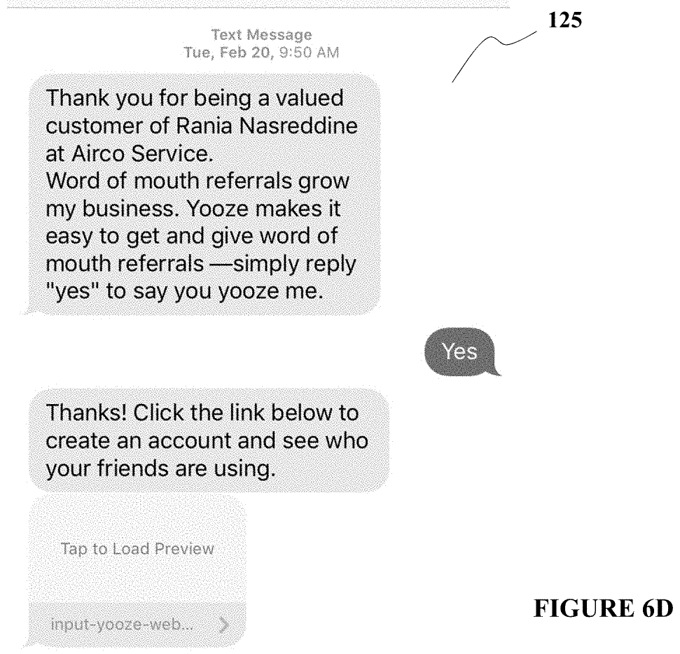

FIG. 6A is a flowchart of a fourth method 400 that may be used with the system 10 to allow a processing device to allow registered users to provide a one-word text message referral. FIGS. 6B-D are exemplary screenshots of the graphical user interface of the system of FIG. 6A. The method includes a plurality of steps. Each method step may be performed independently of, or in combination with, other method steps. Portions of the method may be performed by any one of, or any combination of, the components of the system 10.

In a first step 402, at a referral request page 123 (see FIG. 6B), a business provides customer information, comprising at least a phone number associated with a customer, via the referral website associated with the referral service. In some embodiments, the business may use a bot to facilitate the entry of customer phone numbers without requiring the business to log into the account and manually enter a phone number (see FIG. 6C). The bot allows the business to register a phone number, then text the bot with any new customer phone numbers. The bot then automatically generates a referral request and texts it to the customer. The bot as shown in FIG. 6C may also be used with the method of FIG. 5A (e.g., allowing entry of customer e-mail addresses rather than phone numbers). In one embodiment, the user may save the bot in his phone as a separate contact so that it may be recalled easily.

In a second step 404, the hosting unit 34 receives the customer information.

In a third step 406, the hosting unit 34 sends the customer information to the authentication unit 36.

In a fourth step 408, the authentication unit 36 compares the customer information against information stored about users in database 22 to determine whether the customer information is associated with a registered user.

In a fifth step 410, the authentication unit 36 sends authentication to the hosting unit 34, indicating that the customer information matches a registered user.

In a sixth step 412, the hosting unit 34 sends the authentication information and the customer information to the communications unit 32.

In a seventh step 414, the communications unit 32 sends an SMS (text) message 125 to the user's phone using the customer information. The text message 125 asks whether the user would like to provide a referral for the business in a category, and requests that the user provide a one-word response text message to provide such referral (e.g., “YES”, “Y”, or other one-word response) (see FIG. 6D). In one embodiment, the user may provide a referral for more than one service/category for the same business. In yet another embodiment, the user may be able to provide a referral for the same service/category in different locations (e.g., a hairdresser in New York City and a hairdresser in Los Angeles).

In an eighth step 416, the hosting unit 34 receives an indication that the user sent a message containing the designated one-word response to provide a referral.

In a ninth step 418, the hosting unit 36 sends the indication to the profile management unit 38.

In a tenth step 420, the profile management unit 38 updates the user profile to reflect the referral to the business. If the user already has a referral listed in the same category, the profile management unit 38 replaces the existing referral with the new referral.

In an eleventh step 422, the profile management system 38 updates the business user profile to reflect the referral by the user.

In some embodiments, where the authentication unit 36 determines that the customer information does not match a registered user, the communications unit 32 may still send a text message to the non-registered user's phone using the customer information. However, instead of containing a message requesting a one-word response, it may include a request that the user register with the referral system in order to be eligible to provide a referral. The text message may include a link to the web site of the referral service, whereby the user may register an account according to method 100 (see FIG. 3A).

In yet another embodiment, where authentication unit 36 determines that the customer information does not match a registered user, the communications unit 32 may still send a text message to the non-registered user's phone using the customer information. Instead of soliciting the user to set up an account, the system may accept the user's referral and automatically set up an account for the user based on the provided phone number as a unique identifier and update the user's account with the referral. Thus, the user is not required to independently set up an account, download an application to his phone, or take any other action besides responding to the text message in order to provide the referral.

One-Click Web/App Referral Method

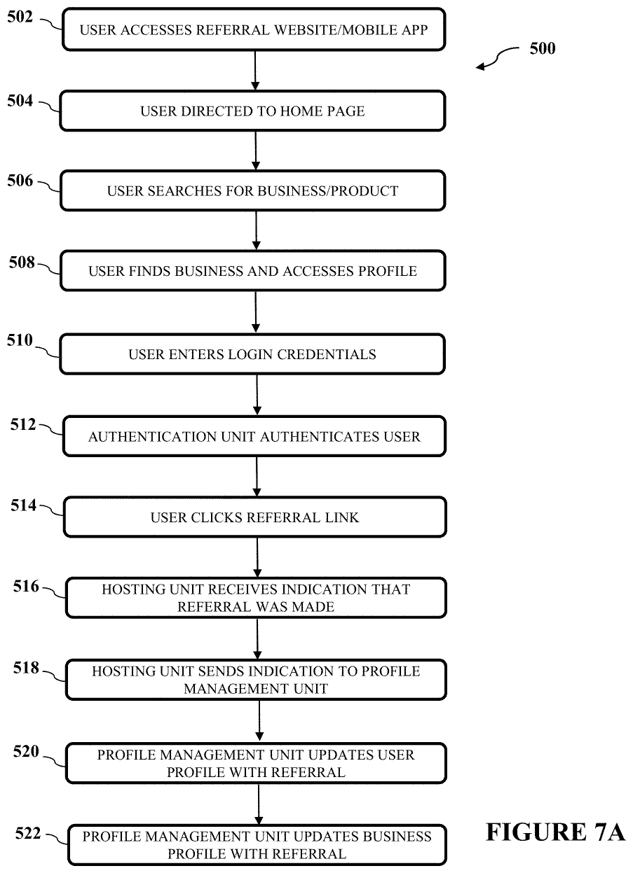

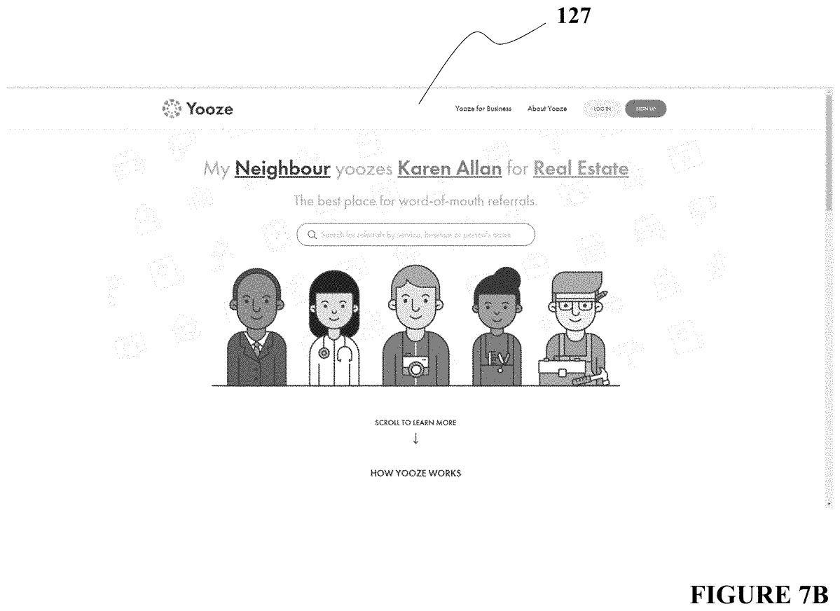

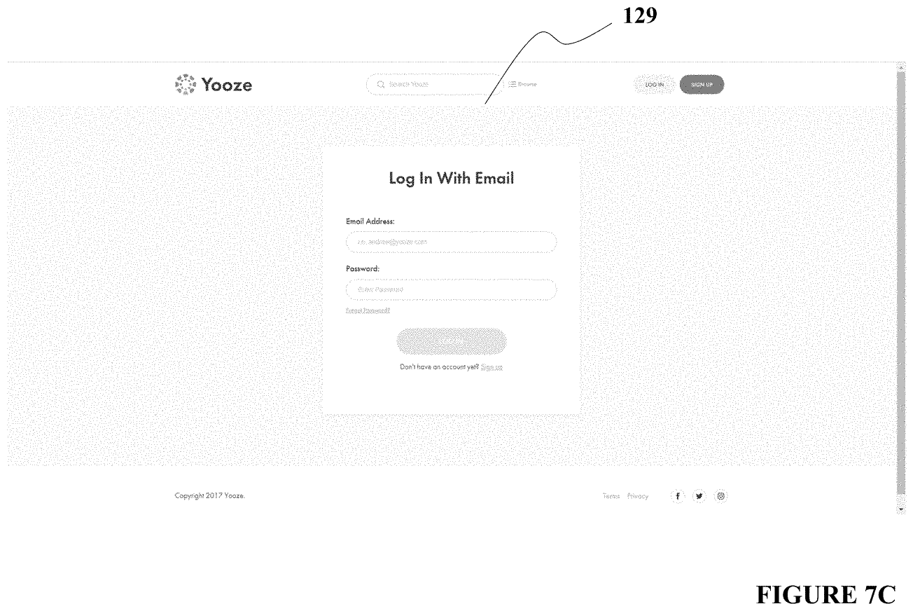

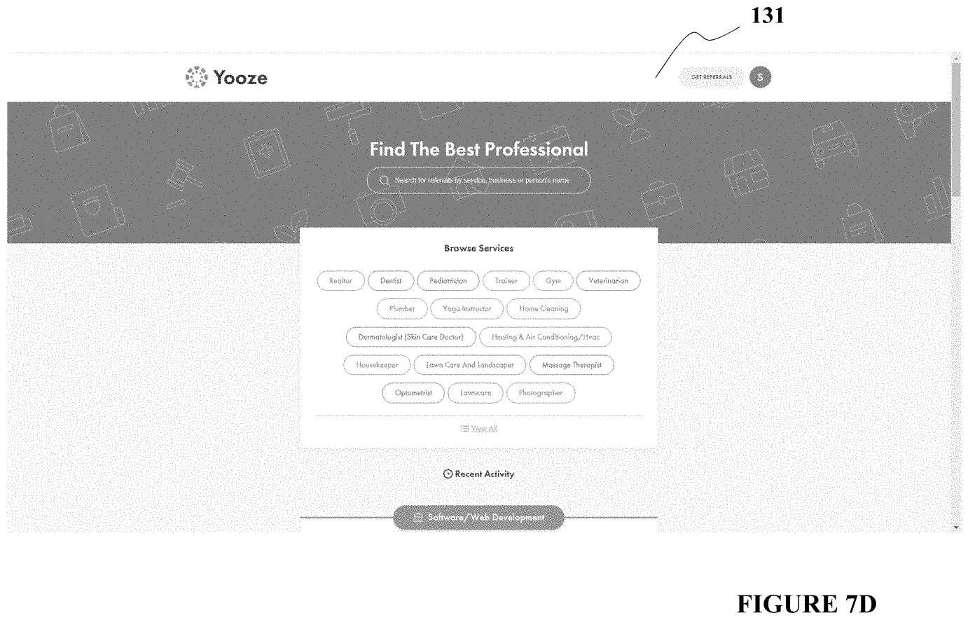

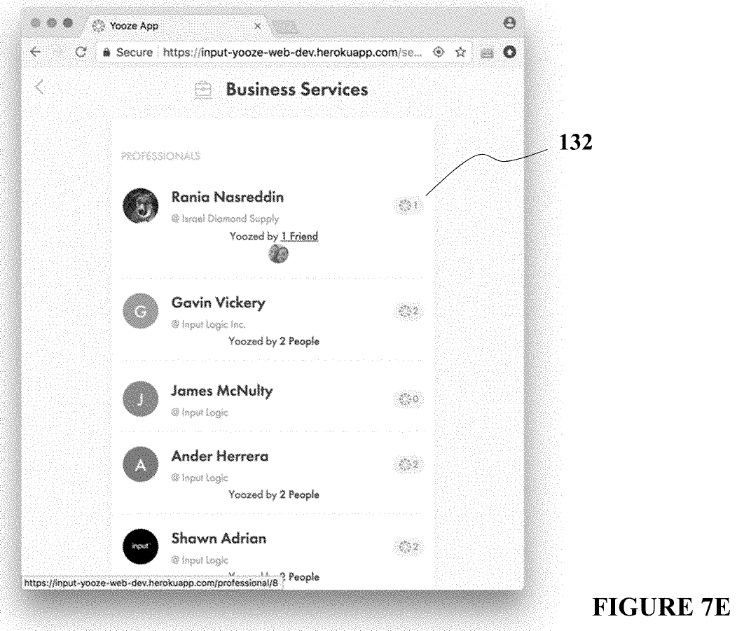

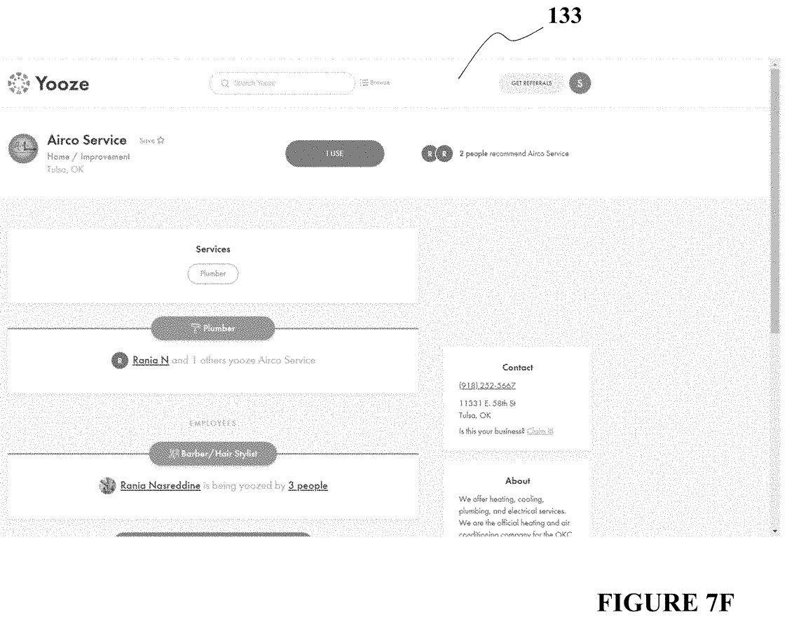

FIG. 7A is a flowchart of a fifth method 500 that may be used with the system 10 to allow a processing device to allow registered users to provide a one-click referral on a website or mobile app. FIGS. 7B-F are exemplary screenshots of the graphical user interface of the system of FIG. 7A. The method includes a plurality of steps. Each method step may be performed independently of, or in combination with, other method steps. Portions of the method may be performed by any one of, or any combination of, the components of the system 10.

In a first step 502, a user accesses a website 127 (or mobile application) associated with a referral service (see FIG. 7B).

In a second step 504, the user may be directed to a home page 131 (see FIG. 7D).

In a third step 506, from the home page 131, the user may search for a provider (e.g., a business, a professional, an individual, by keyword, etc.). The user may also search for their friends to see which providers their friends use. In some embodiments, search results are weighted based on the user's friends' referrals. The search may comprise a keyword/Boolean operator search (e.g., “broken A/C”, “hairdresser”, “wedding dress”, “sushi”). In other embodiments, products and/or businesses may be listed in an online directory, sorted, for instance, alphabetically or by category. The search may be limited geographically (e.g., the user may be required to input a city or zip code), or it may be unrestricted.

Additionally, each listing may have a number associated with it to indicate how many referrals have been provided for that business or professional (e.g., a “3” indicates three distinct referrals). Moreover, each listing may have an indication of how many friends of the user have provided a referral for a particular business or professional (e.g., “referred by 3 friends”) with a clickable link or indicia (e.g., numerical indicia 132) to allow the user to see which friend(s) provided a referral (see FIG. 7E). In some embodiments, where a user provides a one-click referral but chooses not to create a user account with the system, the indicia 132 will still be updated to count the referral.

Optionally, if the user's search results are poor or no results are found based on the user's input, the user may be provided a link to solicit referrals via a linked social media account, which will automatically post a message to the user's linked social media account soliciting a referral for a specific service/category.

In a fourth step 508, the user locates a product or business of interest and accesses the product or business' profile page 133 (e.g., by clicking a link from the search results) (see FIG. 7F).

In a fifth step 510, the user enters login credentials to sign into the user account (e.g., e-mail address/user name and password).

In a sixth step 512, the authentication unit 36 authenticates the user by comparing the login credentials against information stored about users in database 22 to determine that the login credentials are associated with a registered user.

In a seventh step 514, the user clicks a referral link provided on the product or business' profile page 133 to provide the user's referral.

In an eighth step 516, the hosting unit 34 receives an indication that the user clicked the link to provide a referral.

In a ninth step 518, the hosting unit 36 sends the indication to the profile management unit 38.

In a tenth step 520, the profile management unit 38 updates the user profile to reflect the referral to the business. If the user already has a referral listed in the same category, the profile management unit 38 replaces the existing referral with the new referral.

In an eleventh step 522, the profile management system 38 updates the business user profile to reflect the referral by the user.

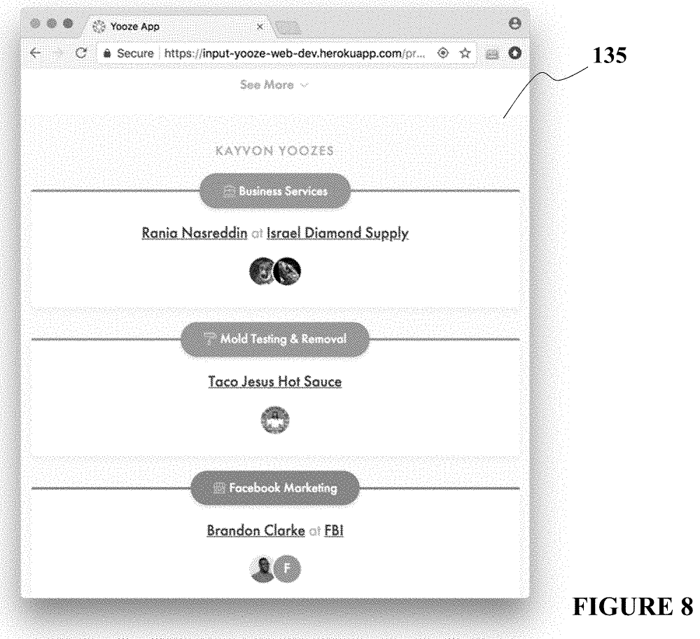

Referring now to FIG. 8, an exemplary screenshot of a graphical user interface featuring a user's referrals of the system shown in FIG. 1 is illustrated. As shown, all of a user's referrals are listed on a single page 135. Unlike other recommendation systems, the present system allows users (who may be required to be registered with the system) to view other user's referrals in one place. This may be helpful if a user has relied on another user's referral and had a positive experience. Thus, he may wish to view the user's other recommendations the next time he is searching for a different business or professional. In some embodiments, the user may rearrange referrals on their own profile based on their own preferences (e.g., place a referral for a hairstylist as the first listing on the profile and a referral for a plumber as the second listing on the profile).

Text Message-Based Searching

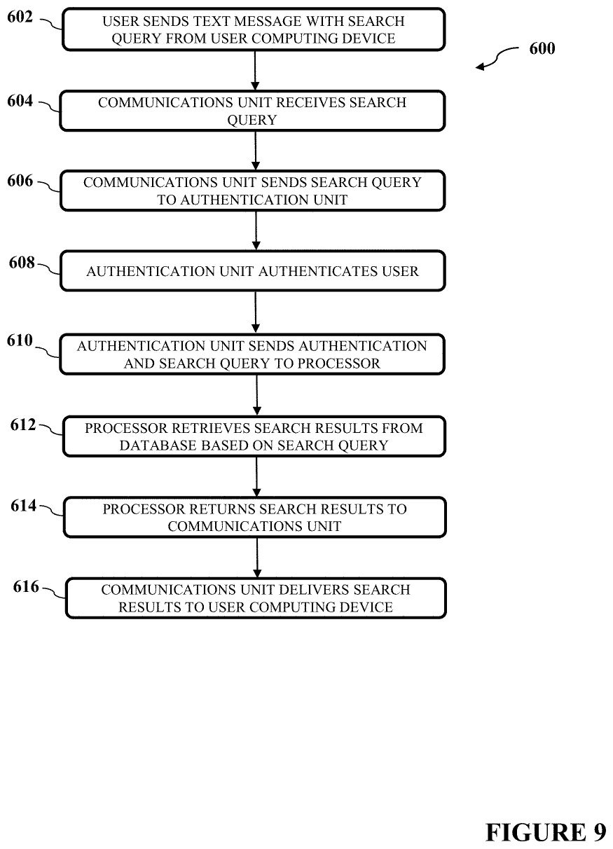

FIG. 9 is a flowchart of a sixth method 600 that may be used with the system shown in FIG. 1 to allow a processing device to allow registered users to search for businesses/professionals via text message. The method includes a plurality of steps. Each method step may be performed independently of, or in combination with, other method steps. Portions of the method may be performed by any one of, or any combination of, the components of the system 10.

In a first step 602, a user sends a text message to a phone number associated with a referral service. The text message may contain a search query, comprising, for example, keyword/Boolean operator search (e.g., “broken A/C”, “hairdresser”, “wedding dress”, “sushi”).

In a second step 604, the communications unit 32 of the referral service receives the search query.

In a third step 606, the communications unit 32 sends the search query to the authentication unit 36.

In a fourth step 608, the authentication unit 36 authenticates the user by comparing the user's phone number against information stored about users in database 22 to determine that the phone number is associated with a registered user.

In a fifth step 610, the authentication unit 36 sends the authentication and the search query to the processor 28A.

In a sixth step 612, the processor 28A uses the search query to search information stored in the database 22 about the user's friends' referrals. In one embodiment, in the event that the user has no friends on the system or the user's friends have provided no relevant referrals, the system will pull referrals from the community of other users on the system.

In a seventh step 614, the processor 28A returns a certain number of search results (e.g., the top three referrals that match the search query based on the user's friends' referrals) to the communications unit 32.

In an eighth step 616, the communications unit 32 delivers the search results to the user computing device 12 via a text message.

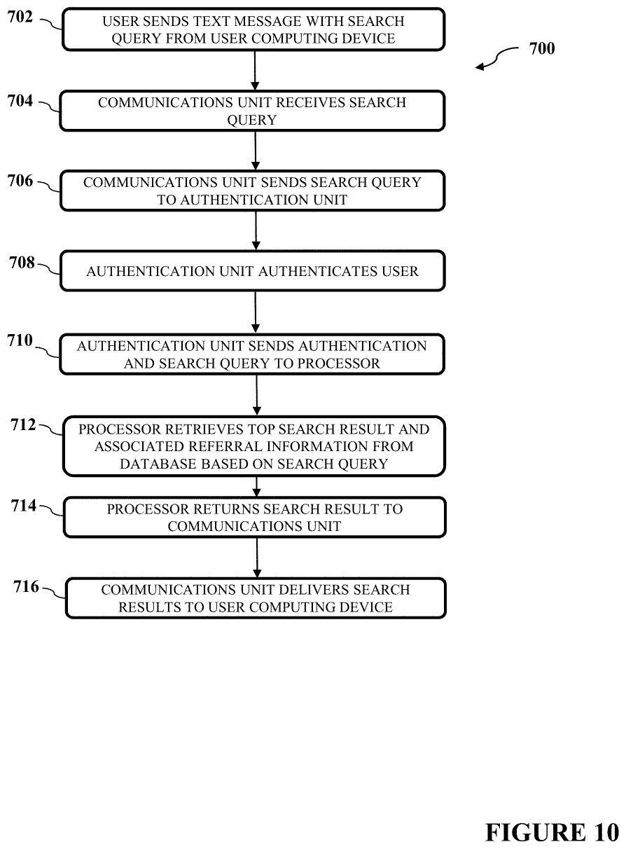

FIG. 10 is a flowchart of a seventh method 700 that may be used with the system shown in FIG. 1 to allow a processing device to allow registered users to search for businesses/professionals via text message. The method includes a plurality of steps. Each method step may be performed independently of, or in combination with, other method steps. Portions of the method may be performed by any one of, or any combination of, the components of the system 10.

In a first step 702, a user sends a text message to a phone number associated with a referral service. The text message may contain a search query, comprising, for example, a business name or a professional's name.

In a second step 704, the communications unit 32 of the referral service receives the search query.

In a third step 706, the communications unit 32 sends the search query to the authentication unit 36.

In a fourth step 708, the authentication unit 36 authenticates the user by comparing the user's phone number against information stored about users in database 22 to determine that the phone number is associated with a registered user.

In a fifth step 710, the authentication unit 36 sends the authentication and the search query to the processor 28A.

In a sixth step 712, the processor 28A uses the search query to search information stored in the database 22 about the user's friends' referrals. In one embodiment, in the event that the user has no friends on the system or the user's friends have provided no relevant referrals, the system will pull referrals from the community of other users on the system.

In a seventh step 714, the processor 28A returns a search result comprising a business (or professional's) name associated with an account registered with the referral service (e.g., the business that most closely matches the user's search query), along with information about how many of the user's friends have provided referrals for that business/professional, to the communications unit 32.

In an eighth step 716, the communications unit 32 delivers the search results to the user computing device 12 via a text message.

Additional Features

In any of the methods provided herein, in some embodiments, if a business/professional receives a referral, a notification e-mail may be sent to the primary e-mail address or a notification text message may be sent to the primary telephone number associated with the business account to inform the business/professional of the referral. Likewise, when a user removes a referral from a business, a notification e-mail may be sent to the primary e-mail address or a notification text message may be sent to the primary telephone number associated with the business account.

In any of the methods provided herein, in some embodiments, a user may search by service category rather than by business or professional's name, thereby eliminating the need for a user to recall specific information in order to search for referrals (e.g., search for “plumber” rather than “Bob Smith”).

In some embodiments, the user may compile an internal list or address book of saved businesses/professionals, which may be searchable in the same way. For example, a user may search her private address book saved on the system for “plumber”. When she does so, the name “Bob Smith” is returned as the name of the plumber for whom the user previously provided a referral or saved to her address book.

In any of the methods provided herein, in some embodiments, search results may be displayed on a map. The map may have a clickable link or other indicia that shows how many friends of a registered user have referred the business/professional. In some embodiments, the friends' names may also be shown.

In any of the methods provided herein, in some embodiments, businesses or professionals may link to the referral service from their own websites and/or social media accounts that have a clickable link or other indicia that shows how many friends of a registered user have referred the business/professional. In some embodiments, the friends' names may also be shown.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media. An apparatus may be expressed in terms of modules and/or units that include one or more discrete hardware components or portions thereof as configured by software (in any form). Furthermore, an apparatus may take the form of one or more elements expressed as a means for performing a specified function. When expressed in such a form, the means are to be interpreted as meaning the combination of hardware components or portions thereof contained within this specification, and any equivalents thereof.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

One advantage of the system described herein is that, for the business owner, customers cannot post negative reviews that may be false, misleading, or incomplete. Thus, the business owner does not need to spend time or energy seeking to ask the customer to amend the review or ask the website moderator to remove the review, so as to avoid loss of business due to an unfair review. Another advantage is that there are no “less than perfect” reviews. For example, although a business with a score of “4.5 out of 5” based on hundreds of reviews would be considered very good, a business with a score of “5 out of 5” based on a single review for a competitor may be placed above the other business in a ranked listing. This may unfairly bias consumers' purchasing decisions if they look solely at the score/rating and do not take the time to understand the context of the system. This also benefits the consumer because it eliminates the need to take additional time to try to parse ratings/scores/rankings to make sense of them before making a purchasing decision. Another benefit to the consumer is that the consumer can easily see which businesses their friends and family members use, eliminating the need to spend time and energy asking for personal referrals.

Yet another advantage for the business owner is that solicitations for referrals is encouraged—since the consumer can make only one referral for any one type of business at a time, and the consumer must be an actual consumer of the business, there is no “gaming the system” to garner more reviews or higher scores, so there is no need to discourage referral solicitations.

Yet another advantage of the system is that individual professionals who otherwise would not qualify for their own “business” page on traditional review platforms are able to have their own pages on the system described herein (e.g., hairdressers who rent space at a salon). This is beneficial for professionals because they are able to rely on their own consumers for referrals rather than the business soliciting/gaining referrals. This system also allows the consumer's reviews to follow the professional, should the professional move to a different location or business. The system also works in the business owner's favor, in some instances, e.g., the business is not denied a referral due to a consumer's poor experience with a single professional. It is also beneficial for the consumer, because typically consumers use only one (or perhaps a few) professional(s) at each business and not recommend the business overall, but would provide a referral for the specific professional(s) they use. For instance, a consumer would provide a referral for her nail technician, but she does not care for the management or aesthetic of the nail salon at which the nail technician works. The consumer is able to provide a referral for the nail technician as her nail technician of choice, but she could choose a different nail salon that she prefers overall. Moreover, the consumer would not need to provide another referral if the technician changes salons; the original referral would follow the nail technician wherever she moves.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

It is to be appreciated that the terms “include,” “includes,” and “including” have the same meaning as the terms “comprise,” “comprises,” and “comprising.”

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A system comprising:
a database stored on a server;
a referral application associated with a referral service and installed on a user device accessible to a user, wherein the user device includes a user interface; and
a processing device of the server, wherein the processing device is in communication with the user device, the processing device including:
a profile management unit configured to store a plurality of referrals provided by the user in a user account associated with the user,
a communications unit configured to send a message to the user requesting the user complete a single step to provide a new referral for a business for a category of goods or services, wherein the single step comprises providing a response selected from not more than two available response options; and
a hosting unit configured to:
receive the new referral from the user, and
send the new referral to the profile management unit for storage in the user account.

2. The system of claim 1, wherein the message comprises an e-mail message.

3. The system of claim 2, wherein the response comprises clicking on a link within the e-mail message.

4. The system of claim 1, wherein the message comprises an SMS message.

5. The system of claim 4, wherein the response comprises an SMS message containing a single word.

6. The system of claim 5, wherein the single word comprises the word “YES”.

7. The system of claim 4, wherein the response comprises an SMS message containing a single character.

8. The system of claim 7, wherein the single character comprises the character “Y”.

9. The system of claim 1, wherein the profile management unit is further configured to:
determine whether the user has an existing referral for the category,
where the user has an existing referral for the category, remove the existing referral, and update the user account to include the new referral.

10. The system of claim 1, wherein:
the hosting unit is further configured to prompt a business user to access the application;
the profile management unit is further configured to prompt the business user to create a business account;
an authentication unit is configured to verify that the business user is eligible to accept referrals by comparing information provided by the business user with business information stored in the database; and
the profile management unit is further configured to update the business account to include the referral from the user.

11. The system of claim 1, wherein personal information about the user is stored in the user account.

12. The system of claim 11, wherein the personal information includes at least one of an e-mail address and a telephone number.

13. The system of claim 1, wherein:
the hosting unit is further configured to receive a search request from the user for a provider of goods or services in a category; and
the communications unit is further configured to display a plurality of results in response to the search request on the user interface, wherein the results are weighted and displayed as ranked based on a number of referrals each provider has received from other users within a network of the user.

14. A computer-implemented method comprising:
prompting a user to access, by a hosting unit, a referral service website associated with a referral service;
prompting the user to create, by a profile management unit, a user account;
verifying, by an authentication unit, that the user is eligible to create the user account by comparing information provided by the user with user information stored in the database;
receiving, by a communications unit, the verification from the authentication unit;
sending, by the communications unit, a message to the user requesting the user complete a single step to provide a referral for a business for a category of goods or services, wherein the single step comprises providing a response selected from not more than two available response options;
receiving, by the hosting unit, the new referral from the user; and
sending, from the hosting unit, the new referral to the profile management unit.

15. The computer-implemented method of claim 14, wherein the message comprises an e-mail message.

16. The computer-implemented method of claim 15, wherein the response comprises clicking on a link within the e-mail message.

17. The computer-implemented method of claim 14, wherein the message comprises an SMS message.

18. The computer-implemented method of claim 17, wherein the response comprises an SMS message containing a single word.

19. The computer-implemented method of claim 18, wherein the single word comprises the word “YES”.

20. The computer-implemented method of claim 17, wherein the response comprises an SMS message containing a single character.

21. The computer-implemented method of claim 20, wherein the single character comprises the character “Y”.

22. The computer-implemented method of claim 14, further comprising:
determining, by the profile management unit, whether there the user has an existing referral for the category;
where the user has an existing referral for the category, removing, by the profile management unit, the existing referral; and
updating, by the profile management unit, the user account to include the referral.

23. The computer-implemented method of claim 14, the method further comprising:
prompting, by the hosting unit, a business user to access the referral service website;
prompting, by the profile management unit, the business user to create a business account;
verifying, by the authentication unit, that the business user is eligible to accept referrals by comparing information provided by the business user with business information stored in the database; and
updating, by the profile management unit, the business account to include the referral from the user.

24. The computer-implemented method of claim 14, wherein creation of the user account requires the user to provide personal information.

25. The computer-implemented method of claim 24, wherein the personal information includes at least one of an e-mail address and a telephone number.

26. The computer-implemented method of claim 14, the method further comprising:
receiving, by the hosting unit, a search request from the user for a provider of goods or services in a category; and
displaying on the user interface, by the communications unit, a plurality of results in response to the search request, wherein the results are weighted and displayed as ranked based on a number of referrals each provider has received from other users within a network of the user.

27. A system comprising:
a database stored on a server;
a referral application associated with a referral service and installed on a user device accessible to a user, wherein the user device includes a user interface; and
a processing device of the server, wherein the processing device is in communication with the user device, the processing device including:
a hosting unit configured to prompt a user to access the application,
a profile management unit configured to prompt the user to create a user account,
an authentication unit configured to verify that the user is eligible to create the user account by comparing information provided by the user with user information stored in the database;
a communications unit configured to:
receive the verification from the authentication unit, and
send a message to the user requesting the user complete a single step to provide a new referral for a business for a category of goods or services, wherein the single step comprises providing a response selected from not more than two available response options;
the hosting unit further configured to:
receive the new referral from the user,
send the new referral to the profile management unit; and
the profile management unit further configured to:
determine whether there the user has an existing referral for the category,
where the user has an existing referral for the category, remove the existing referral, and
update the user account to include the new referral;
the hosting unit further configured to prompt a business user to access the application;
the profile management unit further configured to prompt the business user to create a business account;
the authentication unit further configured to verify that the business user is eligible to accept referrals by comparing information provided by the business user with business information stored in the database; and
the profile management unit is further configured to update the business account to include the referral from the user.

28. The system of claim 27, wherein:
the hosting unit is further configured to receive a search request from the user for a provider of goods or services in a category; and
the communications unit is further configured to display a plurality of results in response to the search request on the user interface, wherein the results are weighted and displayed as ranked based on a number of referrals each provider has received from other users within a network of the user.
